(19) United States
(12) Patent Application Publication
(10) Pub. No.: US 2010/0005045 A1
(43) Pub. Date: Jan. 7, 2010

(54) SITUATION RECOGNIZING APPARATUS, SITUATION RECOGNIZING METHOD, AND RADIO TERMINAL APPARATUS

(75) Inventors: Toshiro Hiraoka, Yokohama-Shi (JP); Kazushige Ouchi, Saitama-Shi (JP); Akihisa Moriya, Tokyo (JP); Miwako Doi, Kawasaki-Shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/428,204

(22) Filed: Apr. 22, 2009

(30) Foreign Application Priority Data
Jul. 1, 2008 (JP) 2008-172176

(51) Int. Cl. G06N 5/00

(52) U.S. Cl. 706/45

(57) ABSTRACT

A situation recognizing apparatus has a situation change detecting unit, being provided with situation information, configured to detect a situation change on the basis of the situation information, a first storage which stores a plurality of situation changes detected by the situation change detecting unit, an input unit which is provided with a user operation, and a second storage which combines the user operation provided to the input unit with the plurality of situation changes stored in the first storage and stores the combined user operation and the situation changes as a unique pattern.

### CROSS REFERENCE TO RELATED APPLICATIONS

This application is based upon and claims the benefit of priority from the Japanese Patent Application No. 2008-172176, filed on Jul. 1, 2008, the entire contents of which are incorporated herein by reference.

### BACKGROUND OF THE INVENTION

1. Field of the Invention

The present invention relates to a situation recognizing apparatus, a situation recognizing method, and a radio terminal apparatus.

2. Related Art

The so-called recommendation services are being provided that recommend items based on a history of items purchased by users on the Internet to the users who purchased items similar to those items. Broadcast program recommendation services are also being provided that learn users' preferences on the basis of the users' television program viewing histories or program recording histories and recommend television programs on the basis of the users' preferences.

These services use meta data such as the types of contents or such as items purchased by users or programs viewed or recorded by viewers or the so-called electronic television guides added to contents. That is, information used for learning preferences is symbols, namely text information.

On the other hand, many research studies have been conducted on recommendation based on data mining of action histories. Action histories represented by time-series signal information such as acceleration sensor information or time-series symbol information such as location information is converted into symbol strings and learned to make recommendations.

In conventional data mining approaches, time-series data such as acceleration sensor data is first divided into analysis segments in a range from 1 to 30 seconds and multiple feature quantities in each of the analysis segments, such as the average, maximum value, and minimum value are detected. Then, the future quantities and time-series information that is separately obtained are used to identify actions such as walking and running by a method such as a clustering, neural network, or binary classification tree method (for example, refer to JP-A 2005-21450(KOKAI)).

In these conventional approaches, actions to be identified such as walking, running, seating, and working are determined beforehand, a combination of appropriate feature quantities that can be classified as these actions and a weighting factor of the combination are detected to create an identification model, and action recognition is performed on the basis of the identification model.

As mobile phones become equipped with location information acquisition functions such as GPS (Global Positioning Service), it has become possible to locate users on some level where they are in outdoor locations. Mobile phones including an electronic money function enable acquisition of location information both in-doors and out-doors by adding information on the locations in which electronic payment was made. Research and development is being performed on recommendation so-called concierge service that uses time-series location information and schedules stored in mobile phones in combination.

In the conventional method in which time-series data is divided into predetermined time units in accordance with the type of action to be identified, feature quantities are extracted from the data to create an identification model by data mining to identify an action, the action to be identified must be defined beforehand.

The conventional method presents no problem as long as very limited actions are to be recognized, such as walking, running, seating, and working. However, real human actions are not limited. In particular, if the result of action recognition based on identification models is to be connected with a service called concierge service that uses mobile terminals such as mobile phones, it is difficult to adapt the action recognition to wide variety of functions of the mobile terminals and new functions developed and added to the mobile terminals.

A method that divides data into analysis segments independently of feature quantities in signal information is tantamount to dividing speech data regardless of words and phonemes uttered, such as “tomorrow”, “plan”, “/t/”, “/o/”, or “/r/”, or presence or absence of utterance. To improve the accuracy of speech recognition, it is essential to extract segments that are distinctive as speech, such as words and phonemes, from speech data. It is required that meaningful segments be extracted in situation recognition as well, like words and phonemes in speech recognition. However, real user actions are often indeterminate and it is difficult to extract such meaningful segments.

The method in which a schedule and location information are combined together is effective provided that a detailed schedule is input. However, there is a problem that not all users input detailed schedules. In addition, most of events entered in schedules in business-use mobile phones are indoor events such as meetings at offices. Electronic payment is rarely made at office and therefore it is difficult to obtain precise indoor location information.

### SUMMARY OF THE INVENTION

According to one aspect of the present invention, there is provided a situation recognizing apparatus comprising:

a situation change detecting unit, being provided with situation information, configured to detect a situation change on the basis of the situation information;

a first storage which stores a plurality of situation changes detected by the situation change detecting unit;

an input unit which is provided with a user operation; and

a second storage which combines the user operation provided to the input unit with the plurality of situation changes stored in the first storage and stores the combined user operation and the situation changes as a unique pattern.

According to one aspect of the present invention, there is provided a situation recognizing method comprising:

detecting a situation change on the basis of situation information;

storing a plurality of the detected situation changes in a first storage; and

when a user operation is provided, storing the plurality of situation changes stored in the first storage in the second storage along with the user operation as a unique pattern.

According to one aspect of the present invention, there is provided a radio terminal apparatus comprising:

an antenna which receives a radio frequency signal and generates a received analog signal;

a receiving unit which amplifies, down-converts, and analog-to-digital converts the received analog signal to generate a digital signal;

a signal processing unit which demodulates the digital signal to generate received data;

a control unit connected to the signal processing unit to control data processing; and

a situation recognizing apparatus, connected to the control unit, including a situation change detecting unit which is provided with situation information and detects a situation change on the basis of the situation information, a first storage which stores a plurality of situation changes detected by the situation change detecting unit, an input unit which is provided with a user operation, and a second storage which combines the user operation provided to the input unit with the plurality of situation changes stored in the first storage and stores the combined user operation and the situation changes as a unique pattern.

### BRIEF DESCRIPTION OF THE DRAWINGS

FIG. 1 is a schematic diagram showing a configuration of a situation recognizing apparatus according to an embodiment of the present invention;

FIG. 2 is a graph showing exemplary variations in acceleration;

FIG. 3 is a graph showing exemplary variations in illuminance;

FIG. 4 is a diagram showing an example of acquisition of a unique pattern;

FIG. 5 is a diagram showing exemplary unique patterns;

FIG. 6 is a diagram showing exemplary unique patterns;

FIG. 7 is a flowchart illustrating a situation recognizing method according to the embodiment;

FIG. 8 is a diagram showing an example of foreseeing of a user operation;

FIG. 9 is a diagram illustrating acquisition of a unique pattern using multiple situation change detecting means; and

FIG. 10 is a schematic diagram showing a configuration of a radio terminal apparatus including a situation recognizing apparatus according to an embodiment of the present invention.

### DESCRIPTION OF THE EMBODIMENTS

Embodiments of the present invention will be described below with reference to the accompanying drawings.

FIG. 1 schematically shows a configuration of a situation recognizing apparatus according to an embodiment of the present invention. The situation recognizing apparatus includes a situation change detecting unit 101, a first storage 102, an input unit 103, a second storage 104, a comparing unit 105, and a presenting unit 106. The situation change detecting unit 101 includes a situation recording buffer 101a.

The situation change detecting unit 101 receives situation information, which is information about a situation, stores the situation information in the situation recording buffer 101a, and detects a situation change by using the situation information. Here, the situation information may be acceleration information output from a acceleration sensor which measures acceleration, illuminance information output from an illuminance sensor which measures brightness, sound information output from a microphone which measures sound, temperature information output from a temperature sensor which measures temperature, azimuth information output from an electronic compass which measures azimuth, atmospheric pressure information output from an atmospheric pressure sensor which measures atmospheric pressure, ambient gas information output from a humidity sensor which senses humidity or a gas sensor which senses a gas such as carbon dioxide gas, or biological information output from a biological sensor, for example. The operating status of a CPU, a remaining battery level, radio signal reception conditions, and incoming calls can also be used as situation information.

Acceleration information is suited for use as situation information because acceleration is often directly relative to actions of users. Illuminance information and sound information often reflect the situations surrounding users and therefore suitable for use as situation information.

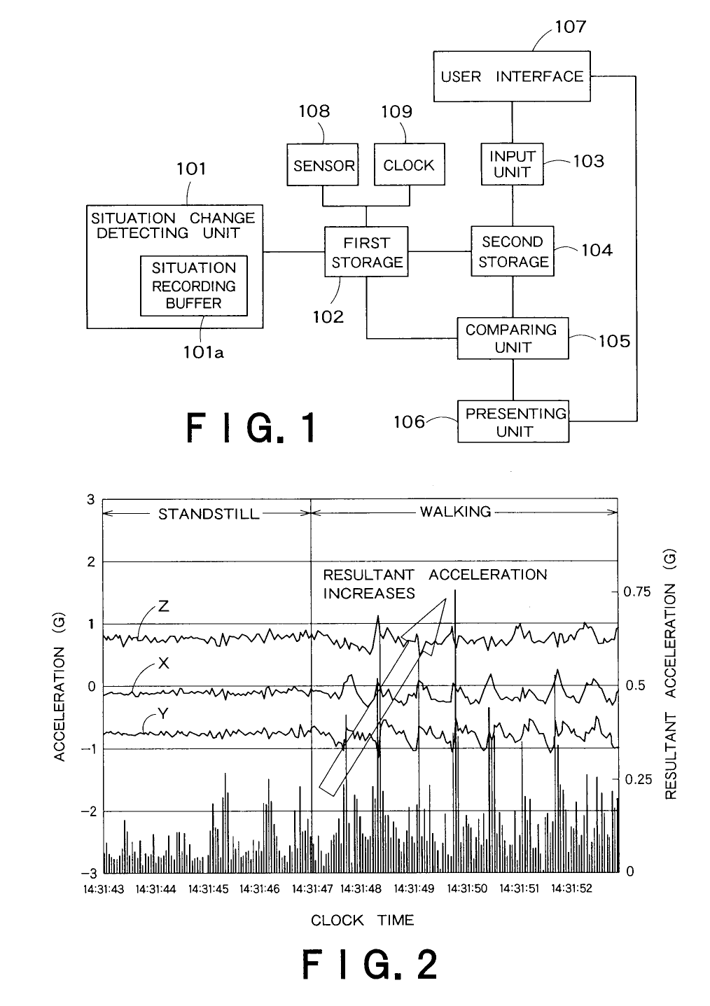

For example, the situation change detecting unit 101 is provided with acceleration information including information on accelerations Xn, Yn, and Zn in the x-, y-, and z-axis directions (horizontal and vertical directions) as shown in FIG. 2 from an acceleration sensor and calculates the resultant acceleration Acc. The equation used for calculating the resultant acceleration Acc is given below.

Acc=\sqrt{(Xₙ−Xₙ₋₁)²+(Yₙ−Yₙ₋₁)²+(Zₙ−Zₙ₋₁)²}

The resultant acceleration Acc is represented by the vertical axis in FIG. 2.

The situation change detecting unit 101 determines situations from changes in the resultant acceleration at intervals of one second, for example. In the example shown in FIG. 2, the resultant acceleration increased after 14:31:47, and therefore a situation change from standstill to walking (behavior change) is detected.

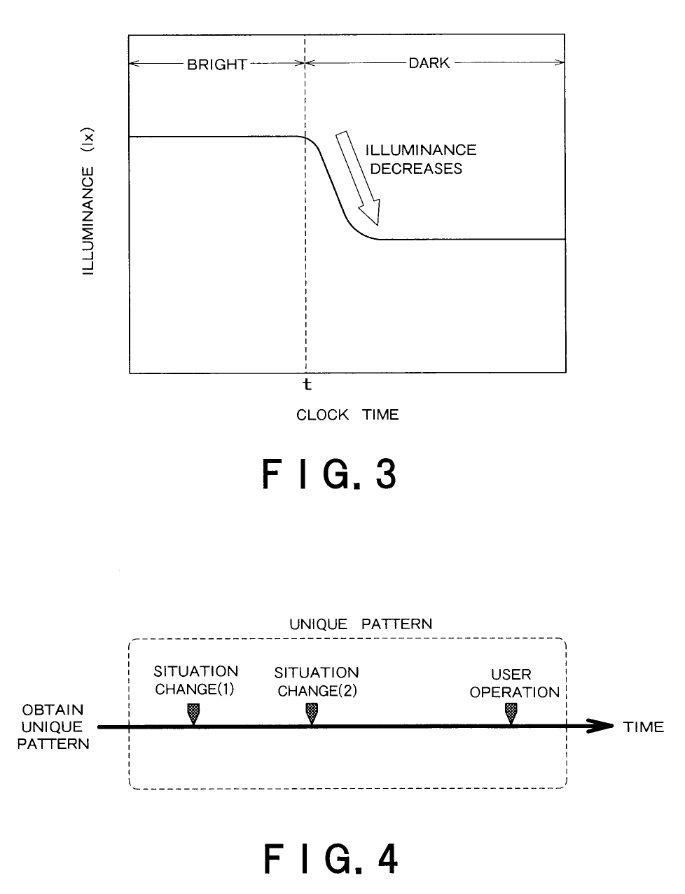

The situation change detecting unit 101 may detect a situation change from illuminance information as shown in FIG. 3 which is output from an illuminance sensor. In the example shown in FIG. 3, the illuminance decreased after time point t and a situation change (illuminance change) from a bright situation to a dark situation is detected. A situation change detected from such illuminance information may occur when the user goes out of a bright room to a dark hallway or the user turns off the lighting of the room.

The method for detecting a situation change from situation information is not limited to a specific one. For example, exceeding a predetermined threshold may be considered to be a situation change.

The various sensors that provide information to the situation change detecting unit 101 may be one of components of the situation change detecting unit 101 or may be installed outside the situation change detecting unit 101.

When the situation change detecting unit 101 detects a situation change, the situation change detecting unit 101 stores the situation change (situations before and after the change) in the first storage 102. A sensor 108 and a clock 109 are connected to the first storage 102 and sensing information from the sensor 108 and time information from the clock 109 may be recorded along with the situation change. The sensor 108 may be a GPS sensor which obtains location information by using radio waves from satellites or a location sensor such as a positioning system which obtains location information from access points of a wireless LAN.

The first storage 102 stores a predetermined number of (for example two) situation changes. When a new situation change is detected by the situation change detecting unit 101 while a predetermined number of situation changes are stored, the oldest situation change is deleted and the new situation change is stored. That is, the first storage 102 contains the predetermined number of latest situation changes.

The number of situation changes to be stored in the first storage 102 may be changed as appropriate. For example, when the number of situation changes detected per unit time is small, the number of situation changes to be stored can be reduced; when the number of situation changes detected per unit time is large, the number of situation changes to be stored can be increased, thereby increasing the accuracy of situation recognition.

When a user operation is input in the input unit 103 through a user interface 107, the input is stored in the second storage 104 as a unique pattern together with the predetermined number of a series of situation changes from the first storage 102 and sensor information. The user interface 107 is a user interface including an input device and, if required, an output device and an information processing device. For example, the user interface 107 may include devices such as a display, keypad, and touch panel.

A unique pattern containing a predetermined number of situation changes (behavior changes) before a user operation as shown in FIG. 4 is stored in the second storage 104.

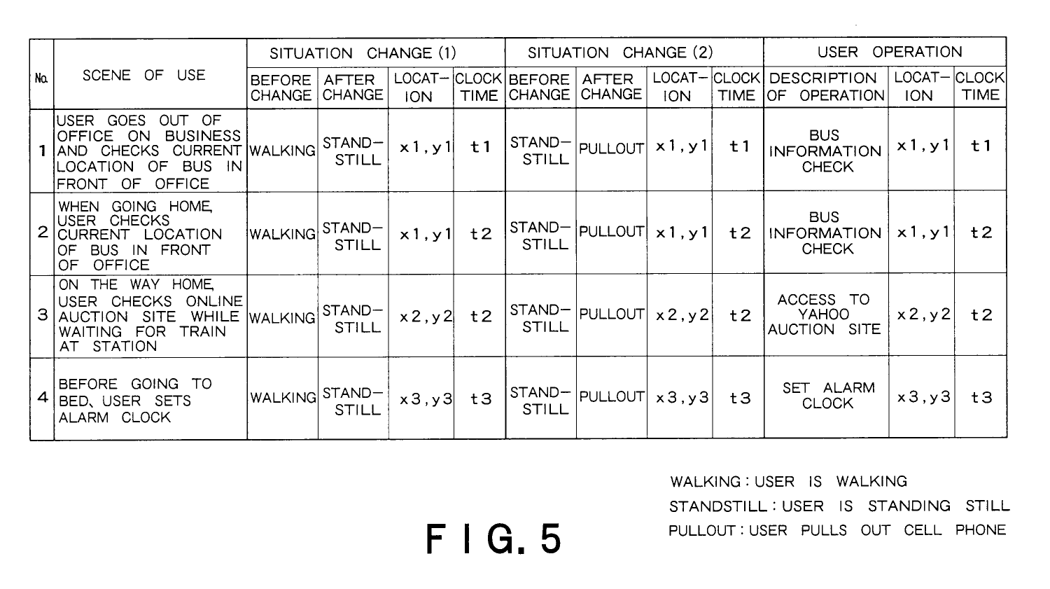

FIG. 5 shows exemplary unique patterns obtained when the number of situation changes stored in the first storage 102 is chosen to be 2. For example, an action, “the user goes out of the office on business and checks the current position of a bus in front of the office.” is represented as a unique pattern containing the following situation changes:

Situation change 1: The user walks out of the office building and stops in front of the office building.

Situation change 2: The user pulls out his/her cell phone including the situation recognizing apparatus.

User operation: The user checks a bus information service with the cell phone to see the status of a bus to take.

The user first walks to go out of the office building and stops in front of the office building to check bus information. At this point, a situation (behavior) change from walking to standstill occurs. Location information (x1, y1) indicating latitude and longitude obtained from the sensor 108, which is a GPS sensor, and situation change time t1 obtained from the clock 109 are stored in the first storage 102 along with the situation change.

Then, when the user pulls out the cell phone, a situation (behavior) change from the standstill to pulling out occurs. The situation change is also stored in the first storage 102 along with location information and clock time.

The user operation of selecting the bus information service is input in the input unit 103 through the user interface 107. The user operation is stored in the second storage 104 as a unique pattern along with the two situation changes stored in the first storage 102.

Other unique patterns are similarly stored in the second storage 104.

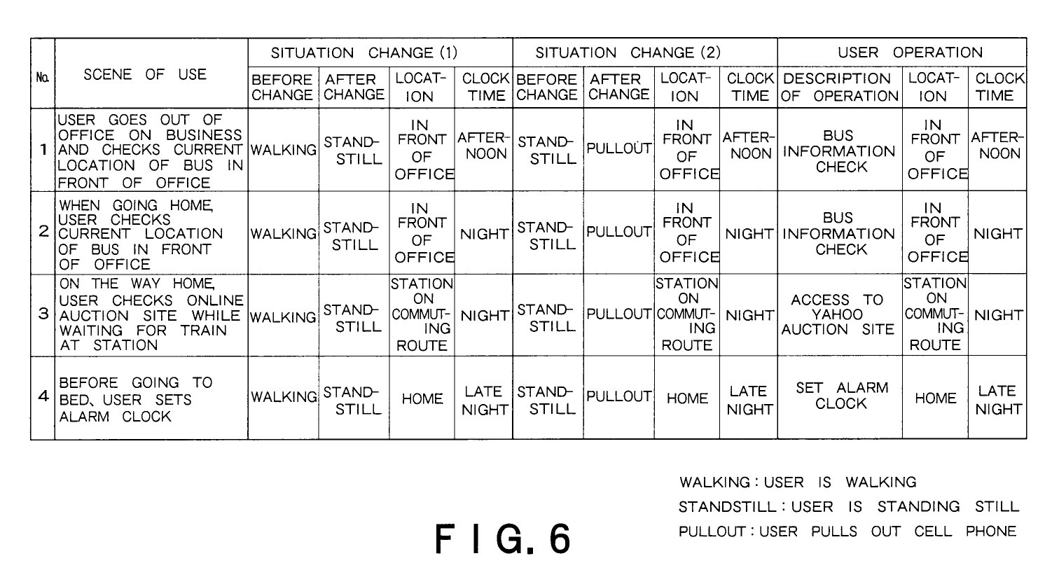

Information stored is not limited to contents as shown in FIG. 5. For example, the location information obtained through GPS may be converted to a place name or street address as shown in FIG. 6 by reverse geocoding. Time information stored may be classified into time periods such as morning, afternoon, evening, night, or late-night.

By using broad information such as “time periods” and “place names” as time information and location information instead of pinpoint values such as clock times and latitude and longitude, the robustness against slight variations of unique patterns can be increased and the amount of information processing can be reduced. Accordingly, “foreseeing” can be performed with lower power consumption and the memory capacity required for storing unique patterns can be reduced.

The comparing unit 105 compares a situation change portion of each of the unique patterns stored in the second storage 104 with a series of situation changes stored in the first storage 102 and extracts a matching unique pattern. The matching unique pattern may be a unique pattern containing a situation change portion that matches or resembles a series of situation changes stored in the first storage 102. Here, “resembles” means that “k” situation changes among “j” situation changes compared match situation changes in the first storage 102 (where “j” is an integer greater than or equal to 2 and “k” is a positive integer that meets the condition k<j), for example. It should be noted that “k” should not be excessively small because the situation change immediately before a user operation is often the same.

The presenting unit 106 presents an operation equivalent to the user operation contained in a unique pattern extracted by the comparing unit 105 or an operation that assists the user operation to the user interface 107. An operation that assists the user operation may be an operation for displaying a user operation menu. For example, it may be an operation for displaying a menu (list) of relevant user operations on a display in order to assist the user operation such as selecting an application such as an electronic mail application or a Web browser or a service such as a bus information service.

The presenting unit 106 may present an operation performing the user operation contained in a unique pattern extracted by the comparing unit 105 or an operation equivalent to such an operation on behalf of the user.

The user interface 107 displays a user operation menu on a display, for example, or executes an equivalent operation on behalf of the user, on the basis of the presented user operation, operation assisting the user operation, or operation executing the equivalent operation on behalf of the user.

That is, the comparing unit 105 “foresees” an operation that the user may perform in the future by comparing a series of situation changes stored in the first storage 102 with the situation change portion of the unique pattern stored in the second storage 104. The presenting unit 106 presents the user operation, an operation assisting the user operation, or an operation performing an operation equivalent to the user operation on behalf of the user, before the user actually performs the user operation.

Including situation changes that occur before a user operation in a unique pattern in this way enables the user operation to be foreseen with a higher degree of accuracy. That is, specific habits of individual users that have not been defined can be accurately foreseen because the course leading to a user operation can be included in a unique pattern as a series of situation changes.

By detecting not only occurrence of a situation change but also the type of the situation change such as a change from “walking” to “standstill”, the efficiency and accuracy of “foreseeing” can be improved.

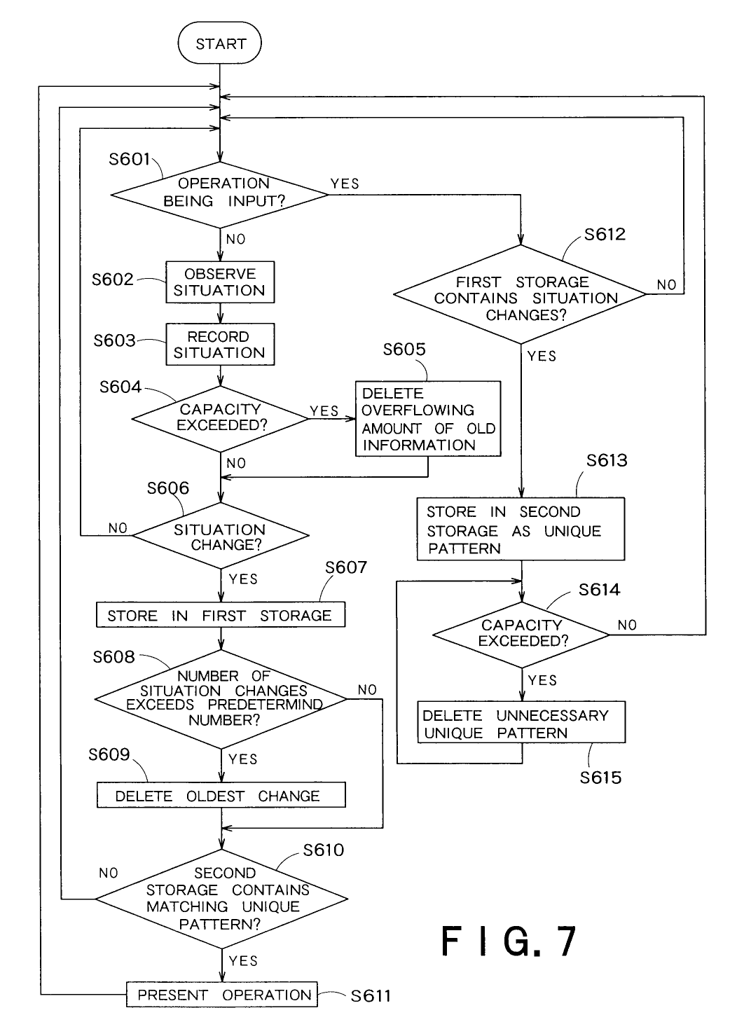

An example of a method for foreseeing a user operation using the situation recognizing apparatus described above will be described with reference to the flowchart shown in FIG. 7.

(Step S601) Determination is made as to whether a user operation is being input in the input unit 103 through the user interface 107. If so, the process proceeds to step S612; otherwise, the process proceeds to step S602.

(Step S602) Information on a situation observed by various sensors such as an acceleration sensor is obtained.

(Step S603) The situation information obtained is stored in the situation recording buffer 101a.

(Step S604) Determination is made as to whether the capacity of the situation recording buffer 101a will be exceeded. If so, the process proceeds to step S605; otherwise, the process proceeds to step S606.

(Step S605) Old situation information among the situation information stored in the situation recording buffer 101a that has the size equivalent to the overflowing amount is deleted from the situation recording buffer 101a.

(Step S606) Determination is made on the basis of the situation information stored in the situation recording buffer 101a as to whether the situation (behavior) has changed. If changed, the process proceeds to step S607; otherwise, the process returns to step S601.

(Step S607) The situations (behaviors) before and after the change are stored in the first storage 102. At this time, the information from the sensor 108 and time information from the clock 109 are also recorded as needed.

(Step S608) Determination is made as to whether the number of situation changes stored in the first storage 102 exceeds a predetermined value. If so, the process proceeds to step S609; otherwise, the process proceeds to step S610.

(Step S609) The oldest situation change among the situation changes stored in the first storage 102 is deleted.

(Step S610) Comparison is made between the pattern of a series of situation changes stored in the first storage 102 and the situation change portion of each of the unique patterns stored in the second storage 104 to find out whether there is a matching or resembling unique pattern. If there is a matching or resembling unique pattern, the process proceeds to step S611; otherwise, the process returns to step S601.

(Step S611) An operation or the like that is equivalent to the user operation contained in the unique pattern detected at step S610 is presented. For example, an operation menu assisting the user operation is presented. Instead of presenting an operation menu, an action that will be performed in response to the user operation may be performed without operation by the user.

(Step S612) Determination is made as to whether the predetermined number of situation changes are stored in the first storage 102. If so, the process proceeds to step S613; otherwise, the process returns to step S601.

(Step S613) The input user operation is stored in the second storage 104 as a unique pattern together with multiple situation changes stored in the first storage 102.

(Step S614) Determination is made as to whether the capacity of the second storage 104 will be exceeded. If so, the process proceeds to step S615; otherwise, the process returns to step S601.

(Step S615) An unnecessary unique pattern among the unique patterns stored in the second storage 104 that has the size equivalent to the overflowing amount is deleted from the second storage 104.

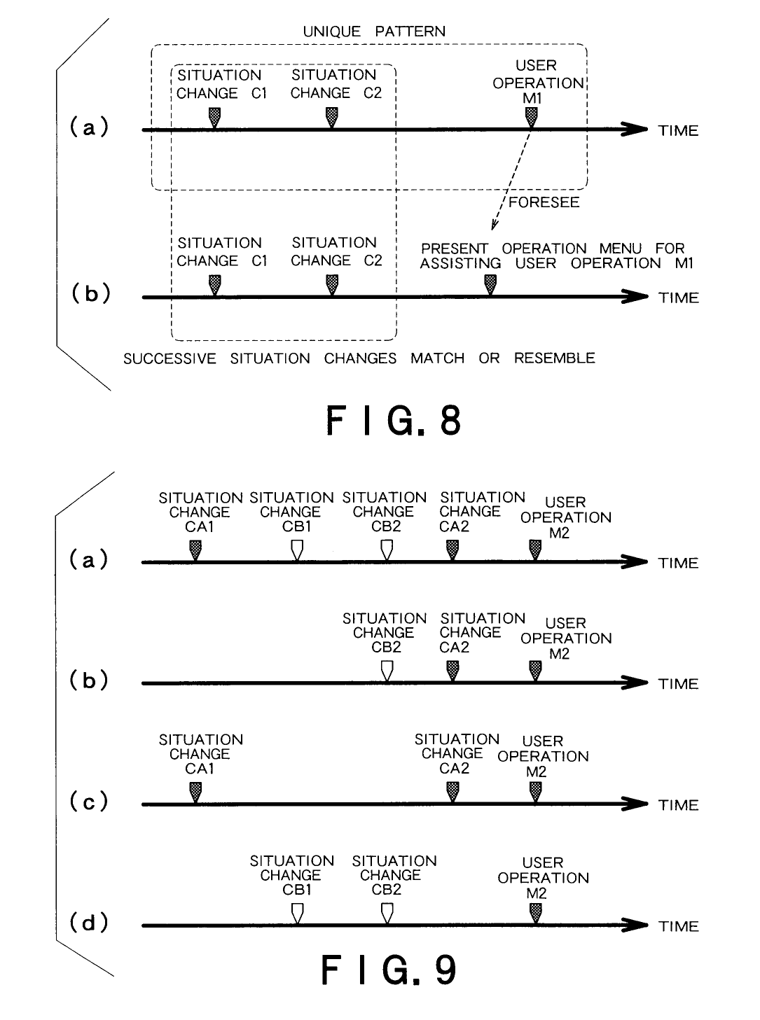

For example, if two situation changes are stored in the first storage 102, situation changes C1 and C2 and a user operation M1 that follows the changes are combined and obtained as a unique pattern as shown in FIG. 8(a).

When subsequently the successive situation changes C1 and C2 occur, the user operation M1 is foreseen and an operation menu or the like that assists the user operation M1 is presented as shown in FIG. 8(b) before the user actually performs the operation.

While two successive situation changes are used in the example, the number of successive situation changes is not limited to a specific number. By including more than one situation change in a unique pattern, the accuracy of “foreseeing” can be improved as compared with a case where only a single situation change is used. If only one situation change is used, it may be difficult to accurately foresee a user operation because the situation change that occurs immediately before a user operation, such as the action of pulling up a cell phone, is often a situation change that occurs before many user operations in common.

On the other hand, by including multiple situation changes in a unique pattern, a situation change other than such a common situation change can be included. In the case of situation change detection using an acceleration sensor as shown in FIG. 2, preferably two or three situation changes are included in a unique pattern. This is because if too many situation changes are included, earlier situation changes, that is, situation changes that are distant from a user operation in terms of time are likely to only weakly correlate with the user operation.

The situation change detecting unit 101 may use more than one method to detect situation changes. For example, a situation change detected with an acceleration sensor may be combined with a situation change detected with an illuminance meter.

That is, the situation change detecting unit 101 may use multiple types of situation information to detect situation changes and combine situation changes detected on the basis of the different types of situation information together to obtain them as a unique pattern. Alternatively, the situation changes may be classified into types of situation information to obtain them as separate unique patterns for the same user operation.

FIG. 9 shows an example in which the situation change detecting unit 101 to which two types of situation information are provided is used to obtain a unique pattern including two successive situation changes. The assumption here is that situation changes CA1 and CA2 have occurred and detected from a first type of situation information and situation changes CB1 and CB2 have occurred and detected from a second type of situation information before a user operation M2, as shown in FIG. 9(a).

In this case, the situation changes detected from the first and second types of situation information may be combined into a unique pattern as shown in FIG. 9(b).

Alternatively, the situation changes detected from the situation information of the first type shown in FIG. 9(c) and the situation changes detected from the situation information of the second type shown in FIG. 9(d) may be included in separate unique patterns.

By obtaining separate unique patterns for the same user operation beforehand in this way, a decrease in the accuracy of “foreseeing” can be prevented that would be caused by changes in the unique patterns due to slight variations in timing at which situation changes are detected.

For example, in a scene in which the user pulls out his/her cell phone while walking out of a bright room to a dark hallway, the timing at which illuminance changes from bright to dark and the timing at which the cell phone is pulled out tend to be replaced with each other. In such a case, two unique patterns would be generated if the situation change detected from illuminance information and the situation change detected from acceleration information were included in one unique pattern in combination as in the example in FIG. 9(b). However, in many cases, it often makes no essential difference whether the cell phone is pulled out immediately before or after going out to the hallway and therefore the method shown in FIG. 9(b) tends to generate unique patterns more than are necessary.

On the other hand, by including the situation change detected from illuminance information and the situation change detected from acceleration information in separate unique patterns as in FIGS. 9(c) and 9(d), generation of multiple unique patterns that are essentially identical as mentioned above can be prevented.

It is not necessarily needed to use multiple types of sensors for obtaining more than one type of situation information. Two types of situation information, for example DC component (a time-average value) and an AC component, may be obtained with one type of sensor. For example, a fluorescent lamp flickers at a certain frequency whereas sunlight does not. Therefore, an illuminance sensor may be used to obtain two types of situation information: time-average illuminance and the frequency of flicker.

The number of situation changes included in a unique pattern may be changed as appropriate depending on the type of situation information.

When more than one type of situation information is obtained, preferably a type of situation information that is often directly relative to actions of the user such as acceleration information is combined with a type of situation information that is often relative to an environment surrounding the user such as illuminance or sound information because situation recognition based on both the user him-/herself and the environment surrounding the user can be performed.

Illuminance information often reflects the user's movement from one room to another or going out of a building, or a situation change in surrounding environment such as a change in lighting of a room. Sound information is also likely to reflect a situation change in the environment surrounding the user because sound information varies depending on situations such as a crowd, a conversation with other people, or a meeting.

Furthermore, by including the clock times at which situation changes occurred and location information from a sensor 108 in a unique pattern in addition to the situation changes and the types of the situation changes, the efficiency and accuracy of “foreseeing” can be improved.

By using broad time and location information such as “time periods” as shown in FIG. 6 instead of pinpoint values such as clock times and latitude and longitude, the robustness against slight variations of unique patterns can be increased and the amount of information processing can be reduced. Accordingly, “foreseeing” can be performed with lower power consumption and the memory capacity required for storing unique patterns can be reduced.

In this way, the situation recognizing apparatus according to the present embodiment is capable of recognizing actions that are not predefined. Furthermore, proper action recognition can be performed and recommendations adapted to individual users can be made even if the users' schedules are not input or if the users' location information is difficult to obtain.

The method according to the present invention can save the memory capacity and, unlike conventional situation recognition methods, does not require complicated information processing for extracting required information from time-series data because only data obtained when a situation change occurred among time-series data is included in a unique pattern and stored in a storage. Accordingly, the situation recognizing apparatus can be constructed with compact circuitry and can be packed in a single semiconductor package (a system-on-chip or system-in-package). Since an external large-capacity memory and an external CPU are not necessarily required, there is little possibility of leakage of unique patterns stored in the second storage 104 to outside. Therefore, the situation recognizing apparatus is superior in terms of security and personal information protection.

Unique patterns that involve personal information need to be present only in the second storage 104 and the comparing unit 105. Therefore, if unique patterns are not output to the outside of the second storage 104 and the comparing unit 105 or are encrypted before they are output to the outside, a very high level of security can be ensured.

The comparing unit 105 in the situation recognizing apparatus according to the embodiment described above may detect the frequency of extraction of a unique pattern stored in the second storage 104, that is, the frequency of occurrence of the same situation change and user operation, and may store the detected frequency in addition.

When an unnecessary unique pattern is to be deleted from the second storage 104 because the capacity of the second storage 104 will be exceeded, the unique pattern with the lowest extraction frequency may be deleted as an unnecessary unique pattern (step S615).

The presenting unit 106 may preferentially present the same operation as that is contained in the unique pattern with the highest use frequency if there is more than one unique pattern containing the same situation change portion but different user operations. Furthermore, when a user operation menu is displayed on the user interface 107, a user operation strongly related to the most frequently used unique pattern may be displayed at the top.

A series of situation changes and a user operation in a unique pattern that is frequently used can be considered as being specific to behavior of the user (owner) of the situation recognizing apparatus. Accordingly, when a user operation contained in a frequently used unique pattern is input after a series of situation changes that differ from a series of situation changes contained in the unique pattern, there is possibility that the operation has been performed by a different person and therefore identification of the person may be requested or notification may be made to a predetermined information addressee in order to ensure security.

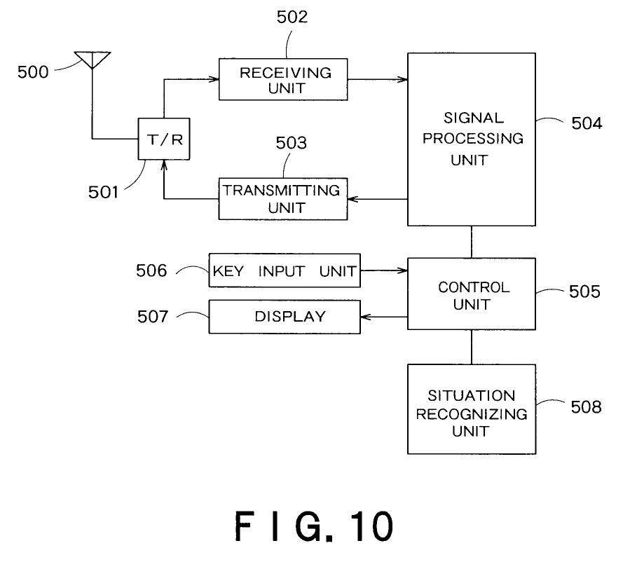

The situation recognizing apparatus described above can be applied to a radio terminal apparatus such as a mobile phone. FIG. 10 shows an exemplary configuration of a radio terminal apparatus including the situation recognizing apparatus. A radio frequency (RF) signal is received at an antenna 500 and the received analog signal is input in a receiving unit 502 through a duplexer 501.

The receiving unit 502 performs processing such as amplification, frequency conversion (down-conversion), and analog-to-digital conversion to the received signal to generate a digital signal. The digital signal is provided to a signal processing unit 504, where processing such as demodulation is performed to generate received data.

In transmission, on the other hand, a signal provided from the signal processing unit 504 is subjected to digital-to-analog conversion and frequency conversion (up-conversion) to be converted to an RF signal and the RF signal is amplified in the transmitting unit 503, then the amplified signal is provided to an antenna 500 through the duplexer 501 and is transmitted as a radio wave.

A control unit 505 controls data processing. A key input unit 506, a display 507, and a situation recognizing unit 508 are connected to the control unit 505. The situation recognizing unit 508 is equivalent to the situation recognizing apparatus according to any of the embodiments described above. The key input unit 506 and the display 507 are equivalent to the user interface 107 of any of the situation recognizing apparatus according to the embodiments described above.

With the configuration described above, the situation recognizing apparatus according to any of the embodiments described above can be applied to a radio terminal apparatus. The situation recognizing unit 508 is capable of obtaining a unique pattern that is most appropriate for the user of the radio terminal apparatus and foreseeing an operation.

What is claimed is:

1. A situation recognizing apparatus comprising:
a situation change detecting unit, being provided with situation information, configured to detect a situation change on the basis of the situation information;
a first storage which stores a plurality of situation changes detected by the situation change detecting unit;
an input unit which is provided with a user operation; and
a second storage which combines the user operation provided to the input unit with the plurality of situation changes stored in the first storage and stores the combined user operation and the situation changes as a unique pattern.

2. The apparatus according to claim 1, wherein the situation change detecting unit comprises a situation recording buffer which stores the situation information.

3. The apparatus according to claim 1, further comprising an acceleration sensor which measures acceleration of the apparatus to generate acceleration information and outputs the acceleration information as the situation information, wherein the situation change detecting unit detects a situation change on the basis of variations in acceleration.

4. The apparatus according to claim 1, further comprising a location sensor which detects a location and outputs location information, wherein the first storage stores the location information output from the location sensor along with the situation change.

5. The apparatus according to claim 1, further comprising a clocking unit which measures time and outputs time information, wherein the first storage stores the time information output from the clocking unit along with the situation change.

6. The apparatus according to claim 1, wherein when the situation change detecting unit detects a new situation change, the oldest situation change among the plurality of situation changes stored in the first storage is deleted.

7. The apparatus according to claim 1, wherein the situation change detecting unit is provided with a plurality of types of situation information and detects a situation change on the basis of each type of situation information, and the user operation provided to the input unit is combined with a plurality of situation changes detected on the basis of the same type of situation information among situation changes stored in the first storage and the combined user operation and the plurality of situation changes is stored in the second storage as a unique pattern.

8. The apparatus according to claim 1, further comprising:
a comparing unit which compares the plurality of situation changes stored in the first storage with a situation change portion contained in the unique pattern stored in the second storage to extract a matching unique pattern; and
a presenting unit which presents the user operation contained in the unique pattern extracted by the comparing unit or an operation assisting the user operation.

9. The apparatus according to claim 1, further comprising:
a comparing unit which compares the plurality of situation changes stored in the first storage with a situation change portion contained in the unique pattern stored in the second storage and extracts a matching unique pattern; and
a presenting unit which presents an operation performing the user operation contained in the unique pattern extracted by the comparing unit.

10. The apparatus according to claim 8, wherein the comparing unit detects the frequency of extraction of the unique pattern and stores the frequency in the second storage.

11. The apparatus according to claim 10, wherein when the comparing unit extracts a plurality of unique patterns, the presenting unit preferentially presents an operation executing a user operation contained in a unique pattern having the highest extraction frequency.

12. The apparatus according to claim 10, wherein when a unique pattern that causes a predetermined storage capacity of the second storage to be exceeded is to be stored, the second storage deletes a unique pattern having the lowest extraction frequency.

13. A situation recognizing method comprising:
detecting a situation change on the basis of situation information;
storing a plurality of the detected situation changes in a first storage; and
when a user operation is provided, storing the plurality of situation changes stored in the first storage in the second storage along with the user operation as a unique pattern.

14. The method according to claim 13, wherein acceleration is measured to generate acceleration information as the situation information and the situation change is detected on the basis of variations in the acceleration information.

15. The method according to claim 13, wherein a location is detected to generate location information and the location information is stored in the first storage along with the situation change.

16. The method according to claim 13, wherein time is measured to generate time information and the time information is stored in the first storage along with the situation change.

17. The method according to claim 13, wherein when a plurality of situation changes are stored in the first storage and a new situation change is detected, the oldest situation change among situation changes stored in the first storage is deleted and the newly detected situation change is stored in the first storage.

18. The method according to claim 13, comprising:
comparing a plurality of situation changes stored in the first storage with a situation change portion of a unique pattern stored in the second storage to extract a matching unique pattern; and
presenting a user operation contained in the extracted unique pattern or an operation assisting the user operation.

19. The method according to claim 13, comprising:
comparing a plurality of situation changes stored in the first storage with a situation change portion of a unique pattern stored in the second storage to extract a matching unique pattern; and
presenting an operation performing the user operation contained in the extracted unique pattern.

20. The method according to claim 18, wherein the frequency of the extractions is detected; and
the frequency of each of unique patterns stored in the second storage is stored in the second storage.

21. The method according to claim 20, wherein when a plurality of unique patterns are extracted by the comparison, an operation performing a user operation contained in a unique pattern having the highest frequency is preferentially presented.

22. A radio terminal apparatus comprising:
an antenna which receives a radio frequency signal and generates a received analog signal;
a receiving unit which amplifies, down-converts, and analog-to-digital converts the received analog signal to generate a digital signal;
a signal processing unit which demodulates the digital signal to generate received data;
a control unit connected to the signal processing unit to control data processing; and
a situation recognizing apparatus, connected to the control unit, including a situation change detecting unit which is provided with situation information and detects a situation change on the basis of the situation information, a first storage which stores a plurality of situation changes detected by the situation change detecting unit, an input unit which is provided with a user operation, and a second storage which combines the user operation provided to the input unit with the plurality of situation changes stored in the first storage and stores the combined user operation and the situation changes as a unique pattern.
